(19) United States
(12) Patent Application Publication
(10) Pub. No.: US 2014/0297272 A1
(43) Pub. Date: Oct. 2, 2014

(54) INTELLIGENT INTERACTIVE VOICE COMMUNICATION SYSTEM AND METHOD

(71) Applicant: Fahim Saleh, Hopewell Jct., NY (US)

(72) Inventor: Fahim Saleh, Hopewell Jct., NY (US)

(21) Appl. No.: 13/855,200

(22) Filed: Apr. 2, 2013

(51) Int. Cl. H04M 3/493; G10L 25/90; G10L 25/93; G10L 25/27

(52) U.S. Cl. CPC H04M 3/4936; G10L 25/27; G10L 25/90; G10L 25/93
USPC 704/208

(57) ABSTRACT

The present invention generally relates to intelligent voice communication systems. Specifically, this invention relates to systems and methods for providing intelligent interactive voice communication services to users of a telephony means. Preferred embodiments of the invention are directed to providing interactive voice communication services in the form of intelligent and interactive automated prank calling services.

### FIELD OF THE INVENTION

The present invention generally relates to intelligent voice communication systems. Specifically, this invention relates to systems and methods for providing intelligent interactive voice communication services to users of a telephony means. Preferred embodiments of the invention are directed to providing interactive voice communication services in the form of intelligent and interactive automated prank calling services.

### BACKGROUND

While numerous systems today provide basic functionality with respect to voice recognition, most of these systems are limited to interpreting a single word, phrase or question into an actionable command. For instance, many would be familiar with telephone based operator systems capable of understanding single word commands (e.g., “yes”, “no”, “operator”) or interpret numbers and letters when given in sequence. More complex systems are able to interpret questions from users, such as voice recognition based search assistants present on most mobile communications platforms, and provide some set of results based on the question asked.

While the ability to interpret simple commands and phrases and generate simple responses is possible in systems currently available in the art, none of these systems are capable of handling the dynamic and complex puzzle that is human speech and interaction. More than just the words spoken goes into the interpretation of the meaning and purpose of those spoken words. Inflection, tone, volume, consistency, pitch, tempo and fluidity are but some of the complex elements that are part of spoken language.

Without these complex elements, meaning and purpose can be lost. For instance, raising pitch at the end of a sentence can frequently denote a question, where without interpreting this pitch change would result in the sentence being interpreted as a statement.

Since current systems are incapable of identifying and processing these complex elements, they are limited to making judgments on pre-programmed or predetermined interpretations of the underlying spoken words.

While the ability to understand and process complex elements of the spoken language would benefit nearly every form of automated voice systems, the usefulness would be specifically advantageous in fields where back-and-forth voice interaction is required/desired, such as in automated prank dialing services.

Current prank dialing services simply walk through a prerecorded audio sample, with pauses in areas where one would assume the recipient would be providing a response to the prerecorded sample. The limitation with these systems is that if the recipient does not respond in a predictable manner, the prank quickly falls apart.

Simple voice recognition does not solve the problem of an unpredictable recipient as tone, pauses and other complex elements need to be interpreted in order to analyze the status of the communications between the recipient and the automated system and process and provide one or more appropriate responses. In order to have a prank dialing service that utilizes automated voice recognition processing, complex speech elements must be interpretable.

Therefore, there is need in the art for systems and methods for providing intelligent interactive voice communication services to users of a telephony means. In particular, there is a need in the art for systems and methods to provide intelligent interactive voice communications related to prank calling services in order to allow for processing of complex speech elements. These and other features and advantages of the present invention will be explained and will become obvious to one skilled in the art through the summary of the invention that follows.

### SUMMARY OF THE INVENTION

Accordingly, it is an aspect of the present invention to provide systems and methods for providing intelligent interactive voice communication services to users of a telephony means.

According to an embodiment of the present invention, a web-based system for providing intelligent interactive voice communications includes: a voice processing module comprising computer-executable code stored in non-volatile memory; a response processing module comprising computer-executable code stored in non-volatile memory; a processor; and a communications means, wherein said voice processing module, said response processing module, said processor, and said communications means are operably connected and are configured to: receive a voice communication from a call participant; identify one or more complex speech elements from said voice communication, wherein said one or more complex speech elements are selected from the group comprising tone, pitch, inflection, pause, tempo, volume, consistency and fluidity; generate a speech analysis based on said one or more complex speech elements; determine a response, wherein said response is based at least in part on said speech analysis; transmit said response via said communications means.

According to an embodiment of the present invention, the response is a complex response type, selected from the group comprising an interruption, a sound response, a third-party contact inclusion and a switch in voice response.

According to an embodiment of the present invention, the complex response type is an interruption that is transmitted concurrently with receipt of said voice communication.

According to an embodiment of the present invention, the speech analysis comprises information selected from the group comprising call participant gender, call participant tone, question identification, statement identification, volume delta and tempo delta.

According to an embodiment of the present invention, the determination off said response is further based on one or more of a call duration, one or more previous responses, one or more selected response types, one or more desired end points and one or more user injected criteria.

According to an embodiment of the present invention, the web-based system includes a user input module comprising computer-executable code stored in non-volatile memory, wherein said user input module said processor, said response processing module and said voice processing module are operably connected and configured to: receive input from a user, wherein said input is utilized in determination of said response.

According to an embodiment of the present invention, the voice processing module, said response processing module, said processor, and said communications means are further configured to: retrieve information related to said call participant from one or more remote sources; and process said information for use in determination of said response.

According to an embodiment of the present invention, a web-based method for providing intelligent interactive voice communications, the method comprising the steps of: receiving, at a communications means, a voice communication from a call participant; identifying, via a processor, one or more complex speech elements from said voice communication, wherein said one or more complex speech elements are selected from the group comprising tone, pitch, inflection, pause, tempo, volume, consistency and fluidity; generating, via said processor, a speech analysis based on said one or more complex speech elements; determining, via said processor, a response, wherein said response is based at least in part on said speech analysis; transmitting said response via said communications means.

According to an embodiment of the present invention, a computer-readable medium is provided, having computer-executable instructions for performing a method comprising the steps of: receiving, at a communications means, a voice communication from a call participant; identifying, via a processor, one or more complex speech elements from said voice communication, wherein said one or more complex speech elements are selected from the group comprising tone, pitch, inflection, pause, tempo, volume, consistency and fluidity; generating, via said processor, a speech analysis based on said one or more complex speech elements; determining, via said processor, a response, wherein said response is based at least in part on said speech analysis; transmitting said response via said communications means.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 is a schematic of an exemplary embodiment of a web-based system in accordance with an embodiment of the present invention;

FIG. 4 is a flowchart of an exemplary method in accordance with embodiments of the present invention; and

FIG. 5 is a flowchart of an exemplary method in accordance with embodiments of the present invention.

### DETAILED SPECIFICATION

The present invention generally relates to intelligent voice communication systems. Specifically, this invention relates to systems and methods for providing intelligent interactive voice communication services to users of a telephony means. Preferred embodiments of the invention are directed to providing interactive voice communication services in the form of intelligent and interactive automated prank calling services.

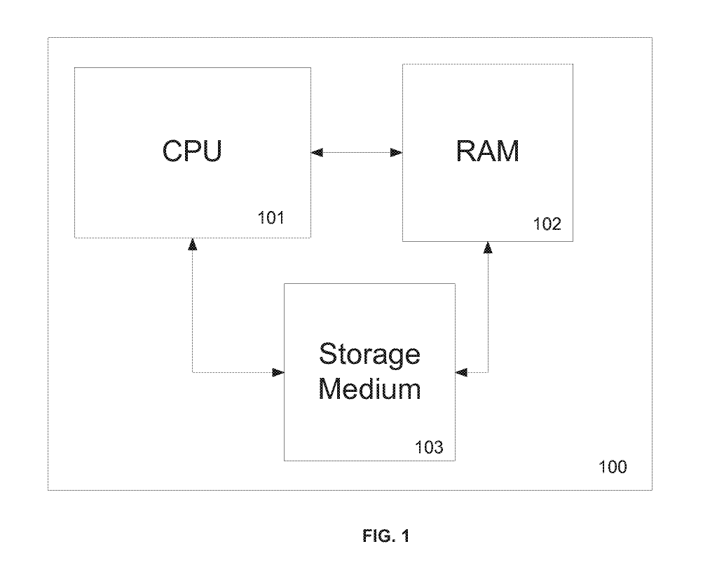

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network; however a user may be able to compose data offline that will be consumed by the system when the user is later connected to a network.

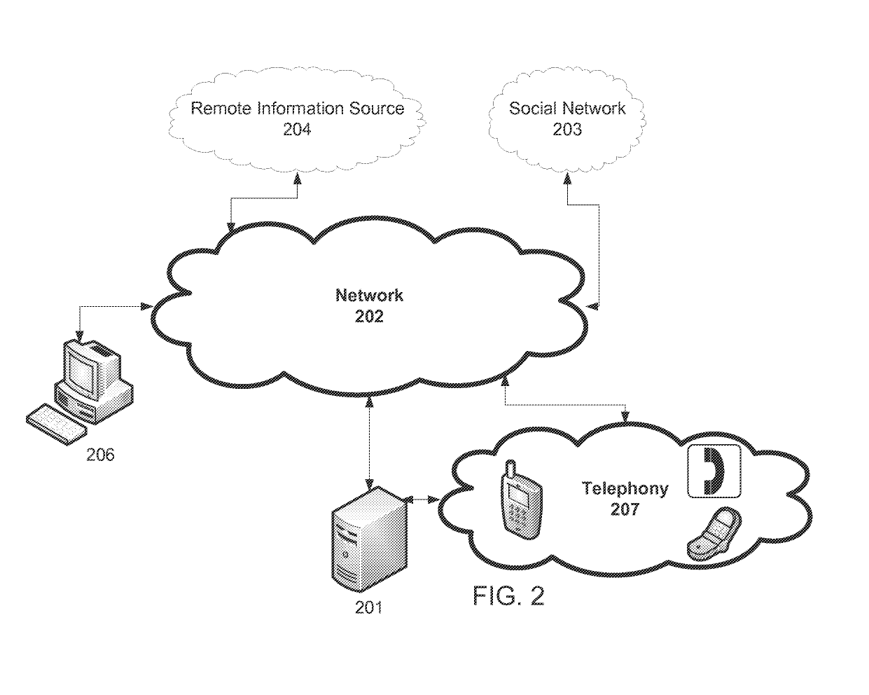

Referring to FIG. 2, a schematic overview of a system in accordance with an embodiment of the present invention is shown. The system is comprised of one or more application servers 201 for electronically storing information used by the system and providing processing of data for presentation to users who remotely connect to the application servers 201 through a networked connection. For instance, one or more application programming interfaces (API) may be provided by the application servers 201, across the Internet, for use and consumption by one or more computing devices belonging to one or more users of the system.

Applications in the application server 201 may retrieve and manipulate information in storage devices and exchange information through a WAN 202 (e.g., the Internet). Applications in application server 201 may also be used to manipulate information stored remotely and process and analyze data stored remotely across a WAN 202 (e.g., the Internet).

According to an exemplary embodiment, as shown in FIG. 2, exchange of information through the WAN 202 or other network may occur through one or more high speed connections. In some cases, high speed connections may be over-the-air (OTA), passed through networked systems, directly connected to one or more WANs 202 or directed through one or more routers. Router(s) are completely optional and other embodiments in accordance with the present invention may or may not utilize one or more routers or other networking hardware/software systems. One of ordinary skill in the art would appreciate that there are numerous ways application server 201 may connect to WAN 202 for the exchange of information, and embodiments of the present invention are contemplated for use with any method for connecting to networks for the purpose of exchanging information. Further, while this application refers to high speed connections, embodiments of the present invention may be utilized with connections of any speed.

Users 206 of the system may connect to application server 201 via WAN 202 or other network in numerous ways. For instance, a component may connect to the system i) through a computing device 206 directly connected to the WAN 202, ii) through a computing device 206 connected to the WAN 202 through a routing device or other networking device, iii) through a computing device 206 via a wireless connection (e.g., CDMA, GMS, 3G, 4G) to the WAN 202. One of ordinary skill in the art would appreciate that there are numerous ways that a component may connect to application server 201 via WAN 202 or other network, and embodiments of the present invention are contemplated for use with any method for connecting to application server 201 via WAN 202 or other network. Furthermore, application server 201 could be comprised of a personal computing device, such as a smartphone, acting as a host for other computing devices to connect to.

Further, with regards to FIG. 2, the systems and methods provided herein could be used in conjunction with, receive information from, communicate information to or otherwise integrate with one or more third-party networks, which may include their own processing and data handling components, such as remote information sources (e.g., news sources, data sites, public data sources) 204 and social networks 203. Each third-party network may be comprised of one or more computing devices and may be capable of functioning independently from the systems described herein and may generally be accessible by the system via one or more APIs.

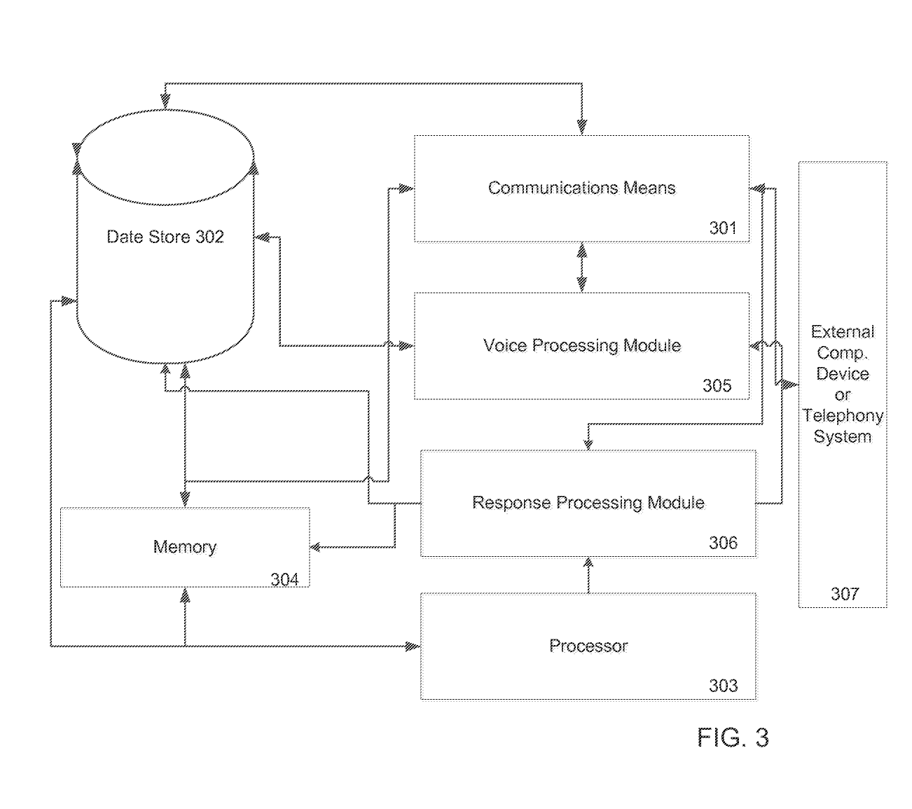

Turning now to FIG. 3, according to an embodiment of the present invention, the system and methods herein described may be implemented through the use of one or more computing devices comprising a communications means 301, one or more data stores 302, a processor 303 a memory 304, a voice processing module 305 and a response processing module 306 all communicatively connected (generally via the communications means 301) to one or more external computing devices or telephony systems 307 (e.g., landline phone, mobile phone, VOIP phone, voice communication system). One or ordinary skill in the art would appreciate that there are numerous types of processors that could be utilized with embodiments of the present invention as well as numerous types of memory (e.g., Flash, RAM, ROM, cache, storage), and embodiments of the present invention are contemplated for use with any type of processor and memory.

According to an embodiment of the present invention, the communications means of the graphic alignment engine may be, for instance, any means for communicating data over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data.

In a preferred embodiment, the data store may comprise one or more databases for storing information related to the processing of complex speech elements as well one or more databases configured for storage and retrieval of responses. Embodiments of the present invention may further include any number of databases used to store numerous other types of information, including user information, call participant information, call history information, speech information, billing information or any combination thereof.

According to an embodiment of the present invention, the voice processing module 305 and response processing module 306 work together to provide the bulk of the intelligent interactive voice communication system functionality. In particular, the voice processing module 305 receives audio data from the communications means or directly from an attached telephony system and processes the audio data in order to identify one or more complex speech elements. Complex speech elements include, but are not limited to, tone, pitch, inflection, pause, tempo, volume, consistency, fluidity or any combination thereof.

In order to identify a complex speech element, the voice processing module analyses the wave forms of the received audio data for specific patterns or changes that would denote particular complex speech elements. For instance, changes in frequency in the audio data would correlate with change in pitch of the call participant. Further examples include identification of a pause by the absence or interruption of audio data over a given range. Processing of the audio data by the voice processing module may include processing of one or more of wavelength, wavenumber, amplitude, sound pressure, sound intensity and other properties of sinusoidal plane waves. The combination of one or more components of the audio data may be used in determining the actual complex speech element to be determined.

The voice processing module may also use other data points in order to analyze and identify complex speech components in the audio data, including information associated with previously received audio data. For instance, changes in the volume, tempo or other tonal qualities between previously received audio data and present audio data may indicate certain complex speech components. For instance, an increase in volume/tempo may indicate agitation, a decrease in tempo may indicate annoyance, an increase in volume with a decrease in tempo may also indicate anger or annoyance, an increase in pitch at the end of a series of audio data may indicate the presence of a question (as opposed to a statement). The delta change in each element can be processed and used to identify complex speech elements. One of ordinary skill in the art would appreciate that there are numerous changes that could be utilized to identify the inclusion of complex speech elements.

The voice processing module may also use standard word/phrase identification to include in the identification and processing of complex speech elements. Common phrases, colloquialisms and other words or indicators may be used and processed by the voice processing module.

According to an embodiment of the present invention, the voice processing module may further utilize advanced processing techniques to enhance the audio data prior to processing. For instance, the voice processing module may run the audio data through a noise cancellation process to remove any background noises from the audio data prior to processing the audio data for complex voice elements. In certain embodiments, the voice processing module may be configured to identify or otherwise detect background noises for use in determining an appropriate response. For instance, loud banging or other aggravated background sounds may indicate the call participant is agitated and the system can use this to select the appropriate response. One of ordinary skill in the art would appreciate that there are numerous types of background types and sounds that could be identified and utilized in determination of responses, and embodiments of the present invention are contemplated to interpret any such background noise and type for use in determination of an appropriate response.

Determination of a response is generally handled by the response processing module, which is configured to utilize information provided to it by the voice processing module in order to identify, retrieve and provide the appropriate response. The response processing module may use a plurality of data points in selecting the appropriate response. For instance, the response processing module may utilize information related to the complex speech elements identified by the voice recognition module in conjunction with a particular call response template selected by a user to determine an appropriate response.

Call response templates are audio templates comprising a plurality of audio responses that are prerecorded, stored in a data store and retrieved for use at the desire of the response processing module. Call response templates generally are composed of a plurality of responses that would be expected based on a particular scenario. For instance, a call template related to a prank call from a telemarketer may be comprised of a plurality of responses that one would expect to be associated with questions and statements made by a call participant in response to receiving a call from a telemarketer (e.g., “no thank you”, “goodbye”, “I am not interested”, “Now is not a good time”). One of ordinary skill in the art would appreciate that there are numerous call response templates and call types that could be utilized with embodiments of the present invention, and embodiments of the present invention are contemplated for use with any call response templates and call types.

Other information that may be used by the response processing module in determination of the appropriate response include information about a call participant (e.g., gender, age, education), information received from one or more third-party networks (e.g., social networks, public information networks), information received from the user or any combination thereof.

The response processing module may be further configured to utilize complex response types. Complex response types are comprised of responses that are above and beyond the use of those found simply in a call response template. Complex response types include, but are not limited to, interruptions, non-verbal sounds, adding third party participants and intelligent switching between call response templates.

Interruptions are responses that are utilized over top of incoming audio data. In this manner, the system can be configured to begin responses while the call participant is still speaking Especially in prank calling services, interruptions can be used with great effectiveness. While interruptions can be timed in any manner, the system can use information related to the complex speech elements in order to tailor the timing of an interruption. For instance, if it is noted a call participant is getting agitated, constantly providing an interruption right as the call participant begins speech after a pause can be effective for furthering agitation or annoyance.

Non-verbal sounds are responses that are directed at inferring that some action is taking place. Examples of non-verbal sound responses include, but are not limited to, sirens, fire sounds, banging, screaming, animal sounds, automobiles, music, horns or any combination thereof. One of ordinary skill in the art would appreciate that there are numerous types of non-verbal sounds that could be utilized with embodiments of the present invention, and embodiments of the present invention are contemplated for use with any type of non-verbal sound.

Certain embodiments of the present invention may be configured to utilize responses whereby a third party participant is added to a call or other communication method. For instance, a user may have configured the system to use a call template that involved two or more intended participants (e.g., husband and wife). The call may start with a single call participant, and then when the system has determined that it the scenario would be benefited by the addition of the third party participant, the system may attempt to add the third party participant to the call. In certain embodiments, the third party participant may be concurrently engaged by the system on another phone line or communications means, allowing for a call template to be running in parallel with two or more intended participants. In other embodiments, the third party participant may be first engaged when directed by the response processing module. In these embodiments, the system may be configured to handle scenarios where the third party participant does not answer or is otherwise not available. In certain embodiments, the system may be configured to handle the scenario where an unintended third party is added to the call (e.g., wrong party answers the phone at the third party participant's number).

When multiple participants are engaged with the system, the system may be configured to track and process voice communications of each participant separately. This can be done by identifying the voices of the various participants and separating out the voices (and potentially other noises) for separate processing by one or more voice processing modules. In other embodiments, the system may be configured to separate out the audio received from the various communications means (e.g., call participant 1—line 1, call participant 2—line 2). One of ordinary skill in the art would appreciate that there are numerous methods for sorting and/or processing voice communications in order to identify voices of individual participants, and embodiments of the present invention are contemplated for use with any such method.

In certain embodiments, the system may be configured to switch between two or more switching between call response templates based on predetermined or preconfigured criteria. Switching between call response templates may be ideal where two or more call templates share commonalities or the response processing module determines a new line of responses would be beneficial for the purpose of the call. For instance, a call template related to a supposed lover of a call participant's significant other could be switched to include a call template of a police officer if the system detects the call participant's complex speech elements indicate anger or agitation. In these embodiments, segue or transition responses may be utilized to rationalize the switching between templates (e.g., supposed lover calls cops which initiate a call back to the original call participant, supposed lover has their cop boyfriend get on the phone). Segue or transition responses may be part of a call template or independent call templates stored with relation to the two associated call templates.

### Exemplary Embodiment

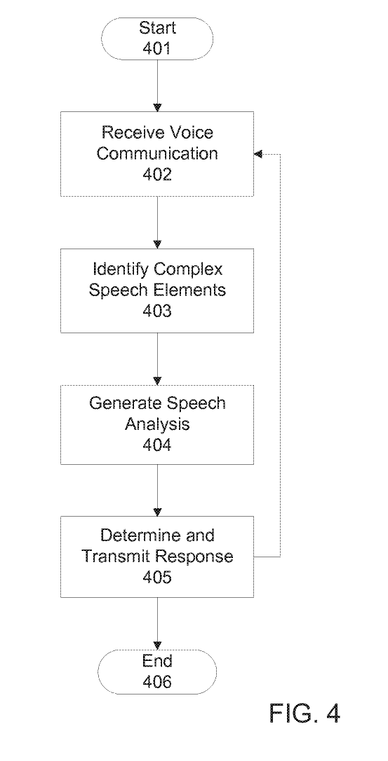

Turning now to FIG. 4, an exemplary method in accordance with an embodiment of the present invention is shown. The method starts at step 401, at which point the system has initiated a call with a call participant. In general, the call is started when a user engages the system to start a desired call. This may require the user to provide certain information about the call type, recipient and other relevant criteria (e.g., phone number, intended participant's name). At step 402, the call has been initiated and the system receives voice communication data. In general, voice communication data may be received via a telephony system, VOIP system or other voice communication means.

At step 403, the system processes the received voice communication data and identifies all complex speech elements contained therein. As noted above, the system may attempt to analyze all the various characteristics of the voice communication data, and may be further configured to pre-process the voice communication data for quality and clarity in order to achieve better results. In certain embodiments of the present invention, the system may be configured to utilize numerous voice processing modules to process various complex speech elements in parallel to reduce total processing time.

At step 404, the system generates a speech analysis which is will be passed to and utilized by the response processing module. In preferred embodiments, the speech analysis is a data object containing all identified complex speech elements and the relation there between as well as any simple speech elements and speech-to-text data provided through processing.

At step 405, the system determines an appropriate response, based at least in part on the information contained in the speech analysis provided from the voice processing module to the response processing module. As noted above, the responses may be further based on information related to other data, including real-time (or near real-time) input from a user. At this point, the system may loop through steps 402-405 as many times as desired or necessary to complete the call. After complete, the process terminates at step 406.

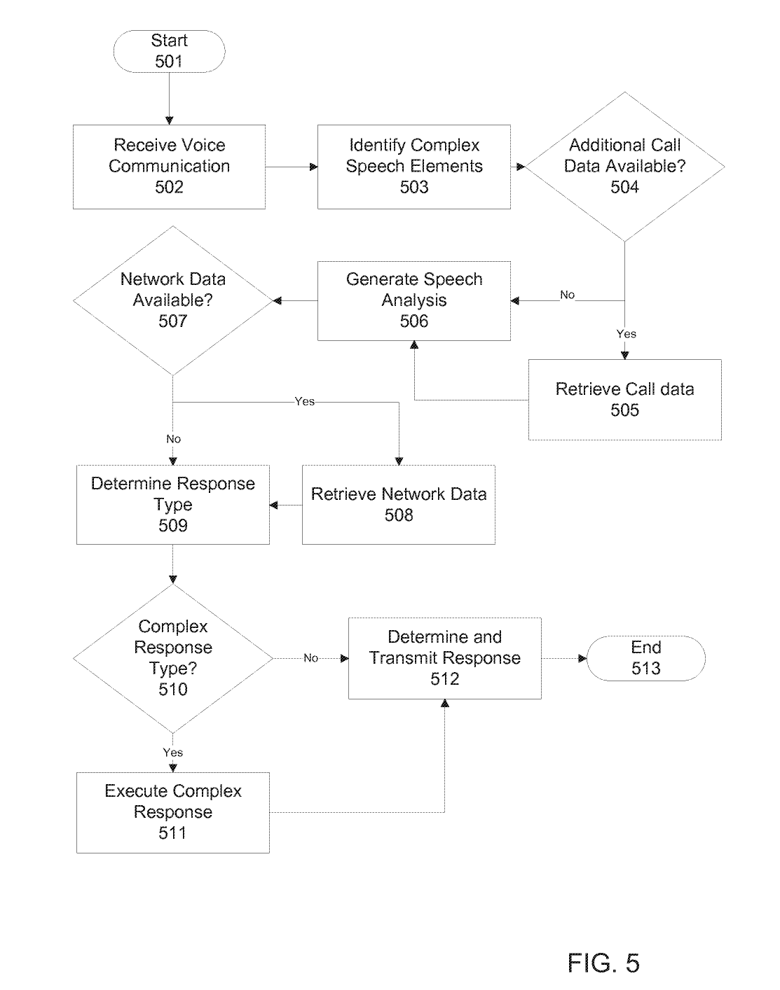

Turning now to FIG. 5, an exemplary process flow for advanced intelligent interactive voice communication system is shown. The method starts at step 501, at which point the system has initiated a call with a call participant. In general, the call is started the same way as noted in FIG. 4 above.

At step 502, the system receives voice communication data, the same as described above in step 402 with respect to FIG. 4 and step 503 mimics the outline above for step 403. At step 504, however, the system determines if there is additional call data available. On a new call, there will be little or no call data available. Call data may have been provided by a user at the start of the process, but most call data comes with ongoing communications with the call participant(s). As detailed above, call data may include data points such as current call length, various changes in user's voice characteristics, mood, background noises, or any other data associated with the call up to the present.

If call data is available, the system retrieves the call data for use in the generation of the speech analysis data object at step 505. Whether no call data was available or if it was retrieved in step 505, the process moves to step 506 where the speech analysis object is generated.

At step 507, the system checks to see if network data is available. Network data, as described above, is any publicly available data that the system has been made aware of about the user (e.g., social networking information, blogs, public postings, public database information). If network data is available, the system attempts to collect all available network data, at step 508.

Whether no network data was available or if it was retrieved at step 508, the system uses all information in its possession at step 509 to determine a call response type.

At step 510, the system identifies whether the call response type selected includes a complex response type. If so, the system executes the complex response portion of the response or retrieves information regarding the complex response type at step 511 and moves to step 512.

At step 512, the system determines the response and, whether in conjunction with the complex response identified in step 511 or without, and transmits the appropriate response. Steps 502-512 may be looped numerous times on a single call. Once the call is stopped, the process terminates at step 513.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A web-based system for providing intelligent interactive voice communications, the system comprising:
a voice processing module comprising computer-executable code stored in non-volatile memory;
a response processing module comprising computer-executable code stored in non-volatile memory;
a processor; and
a communications means,
wherein said voice processing module, said response processing module, said processor, and said communications means are operably connected and are configured to:
receive a voice communication from a call participant;
identify one or more complex speech elements from said voice communication, wherein said one or more complex speech elements are selected from the group comprising tone, pitch, inflection, pause, tempo, volume, consistency and fluidity;
generate a speech analysis based on said one or more complex speech elements;
determine a response, wherein said response is based at least in part on said speech analysis;
transmit said response via said communications means.

2. The system of claim 1, wherein said response is a complex response type, selected from the group comprising an interruption, a sound response, a third-party contact inclusion and a switch in voice response.

3. The system of claim 2, wherein said complex response type is an interruption that is transmitted concurrently with receipt of said voice communication.

4. The system of claim 2, wherein said speech analysis comprises information selected from the group comprising call participant gender, call participant tone, question identification, statement identification, volume delta and tempo delta.

5. The system of claim 1, wherein determination off said response is further based on one or more of a call duration, one or more previous responses, one or more selected response types, one or more desired end points and one or more user injected criteria.

6. The system of claim 1, further comprising a user input module comprising computer-executable code stored in non-volatile memory, wherein said user input module said processor, said response processing module and said voice processing module are operably connected and configured to:
receive input from a user, wherein said input is utilized in determination of said response.

7. The system of claim 1, wherein said voice processing module, said response processing module, said processor, and said communications means are further configured to:
retrieve information related to said call participant from one or more remote sources; and
process said information for use in determination of said response.

8. A web-based method for providing intelligent interactive voice communications, the method comprising the steps of:
receiving, at a communications means, a voice communication from a call participant;
identifying, via a processor, one or more complex speech elements from said voice communication, wherein said one or more complex speech elements are selected from the group comprising tone, pitch, inflection, pause, tempo, volume, consistency and fluidity;
generating, via said processor, a speech analysis based on said one or more complex speech elements;
determining, via said processor, a response, wherein said response is based at least in part on said speech analysis;
transmitting said response via said communications means.

9. The method of claim 8, wherein said response is a complex response type, selected from the group comprising an interruption, a sound response, a third-party contact inclusion and a switch in voice response.

10. The method of claim 9, wherein said complex response type is an interruption that is transmitted concurrently with receipt of said voice communication.

11. The method of claim 8, wherein said speech analysis comprises information selected from the group comprising call participant gender, call participant tone, question identification, statement identification, volume delta and tempo delta.

12. The method of claim 8, wherein determination off said response is further based on one or more of a call duration, one or more previous responses, one or more selected response types, one or more desired end points and one or more user injected criteria.

13. The method of claim 8, further comprising the step of:
receiving input from a user, via a user input module, wherein said input is utilized in determination of said response.

14. The method of claim 8, further comprising the steps of:
retrieving information related to said call participant from one or more remote sources; and
processing said information for use in determination of said response.

15. A computer-readable medium having computer-executable instructions for performing a method comprising the steps of:
receiving, at a communications means, a voice communication from a call participant;
identifying, via a processor, one or more complex speech elements from said voice communication, wherein said one or more complex speech elements are selected from the group comprising tone, pitch, inflection, pause, tempo, volume, consistency and fluidity;
generating, via said processor, a speech analysis based on said one or more complex speech elements;
determining, via said processor, a response, wherein said response is based at least in part on said speech analysis;
transmitting said response via said communications means.

16. The computer-readable medium of claim 15, wherein said response is a complex response type, selected from the group comprising an interruption, a sound response, a third-party contact inclusion and a switch in voice response.

17. The computer-readable medium of claim 16, wherein said complex response type is an interruption that is transmitted concurrently with receipt of said voice communication.

18. The computer-readable medium of claim 16, wherein said speech analysis comprises information selected from the group comprising call participant gender, call participant tone, question identification, statement identification, volume delta and tempo delta.

19. The computer-readable medium of claim 15, wherein determination off said response is further based on one or more of a call duration, one or more previous responses, one or more selected response types, one or more desired end points and one or more user injected criteria.

20. The computer-readable medium of claim 15, further comprising the step of:
receiving input from a user, via a user input module, wherein said input is utilized in determination of said response.
